(19) United States
(12) Patent Application Publication
(10) Pub. No.: US 2025/0340423 A1
(43) Pub. Date: Nov. 6, 2025

(54) SYSTEM, METHOD AND DEVICE FOR TOTAL CONTROL OF CRAFT BREWERIES

(71) Applicant: AOSI INTELLIGENT TECHNOLOGY (HK) LIMITED, Hong Kong (CN)

(72) Inventors: Aviel DAFNA, Salvador - BA (BR); Carlos Eduardo Tanajura Da SILVA, Salvador - BA (BR); Daniel Amaral De SOUZA, Salvador - BA (BR); Frederico Garcia De OLIVEIRA, Salvador - BA (BR); Jessean Da Paz ALVES, Salvador - BA (BR); Jotelly Barros OLIVEIRA, Salvador - BA (BR); Lucas Da Hora HEGOUET, Salvador - BA (BR); Rafael Da Mata Neri KIELMAN, Salvador - BA (BR)

(73) Assignee: AOSI INTELLIGENT TECHNOLOGY (HK) LIMITED, Hong Kong (CN)

(21) Appl. No.: 18/870,056

(22) PCT Filed: May 24, 2023
(86) PCT No.: PCT/BR2023/050160

§ 371 Date: Nov. 27, 2024

(30) Foreign Application Priority Data
May 27, 2022 (BR) 1020220104280

(51) Int. Cl. B67D 1/08; B67D 1/12

(52) U.S. Cl. CPC B67D 1/0888; B67D 1/0884; B67D 1/1275; B67D 2001/1265

(57) ABSTRACT

A system, method, and device to promote a compact and direct solution for craft breweries to distribute their products via kegs instead of using stainless steel and CO2 barrels, where a polymeric barrel containing an internal plastic balloon is used. This balloon is filled with beer, and, as it is filled the internal volume of the barrel is occupied, however, the internal volume is not fully filled by the balloon with beer. When full, pressurized atmospheric air is applied, without the need for filtration, since, due to having an internal plastic balloon, atmospheric air does not meet the beer. As the beer-filled barrel is filled with air, the plastic balloon is evenly crushed from all directions. While the inner plastic bag is emptied, the internal pressure must be restored with pressurized air. In the end, there is a remnant of +−2% of the total volume of the beer.

### FIELD

The present invention refers to a new system, a method and a device to promote a compact and direct solution for craft breweries to distribute their products via Kegs, instead of using stainless steel and CO2 barrels, where a polymeric barrel containing an internal plastic balloon (Keg) is used. This balloon is filled with beer, and as it is filled the internal volume of the barrel is occupied; however, the internal volume is not fully filled by the balloon with beer. When full, instead of using CO2, pressurized atmospheric air is applied, without the need for filtration, since, due to having an internal plastic balloon, atmospheric air does not meet the beer. As the beer-filled barrel is filled with air, the plastic balloon is evenly crushed from all directions. While the inner plastic bag is emptied, the internal pressure must be restored with pressurized air. In the end, there is a remnant of +−2% of the total volume of the beer. In this way, the Keg content is served to its entirety, avoiding waste.

The system, method and device for total control of craft breweries, object of the present invention, is intended for breweries in general and particularly for craft breweries, providing breweries with greater control of their assets, by being able to manage specific data at the end of the cold chain, such as temperature, volume, consumption and id of customers.

The system, method and device for total control of craft breweries, object of the present invention, has the main objective of offering breweries a compact, innovative, intelligent and efficient solution to manage specific data at the end of the cold chain, such as temperature, volume, consumption and id of customers, through beer Kegs served the Keg content to its entirety avoiding waste.

### BACKGROUND

The solution presented here was born from the need for breweries to sell their products in a democratized way, having full control of their sales. Today, craft breweries have difficulty disposing of their stock due to the total cost of production, since, in the face of large breweries, microbreweries are unable to dilute the fixed costs in their production, causing a high price per liter of their product.

The cost of bottled craft beers tends to be higher, even more so when they are sold in markets, which further increases the value by adding the fees of the establishment itself. An alternative to craft breweries is kegs, which are commonly 18 to 40 L stainless steel containers, in which CO2 is used to extract beer from them. These plugs provide breweries with a greater flow of their inputs, in addition to being able to reduce the value per liter, thus increasing the attractiveness of their product to end customers.

However, keg sales represent on average 30% of the total sales volume, due to some difficulties in the structure and monitoring of the cold chain. Often restaurants and bars do not contain taps to serve beer from kegs because of the initial investment, since only one tap is an investment of around R$20,000, apart from maintenance costs. In addition, microbreweries cannot keep track of the end of the cold chain, that is, they do not have devices to verify how their product is being served, or the quantity that is sold. This lack of audit causes the supplier to lack information and may in some cases suffer losses. Thus, the proposed system and method gives breweries greater control of their assets, as they can manage specific data at the end of the cold chain, such as temperature, volume, consumption and id of the customer.

There are some patent documents that describe the system and methods for serving beers, of different configurations and operations, but none of these documents presents the configuration and operation as proposed in this invention. Among these documents, the following can be highlighted.

Patent document BR 112013031568-7, CONTAINER FOR STORING A LIQUID FOOD AND DISTRIBUTING IT UNDER PRESSURE, which describes a container (1) for storing a liquid foodstuff (4) and distributing it under pressure in consumer portions, via a distribution channel that can be closed, wherein it comprises a rigid outer container (2), a flexible inner container (3) for the food (4), and at least one intermediate container (5) surrounding the inner container (3), whereby an intermediate container (5) on the one hand, and another intermediate container (5) or the inner container (3) located within it, on the other hand, define a space (16), whereby the space (16) is provided with a pressure means and/or the container (1) is equipped with a connection (23) connected to the space by a pressure means source (24);

Patent document BR 112016021844-2, BARREL CONNECTOR FOR COUPLING A DISTRIBUTION LINE AND A GAS LINE TO A BARREL, SET OF A BARREL CONNECTOR, AND METHOD FOR CONNECTING OR DISCONNECTING A BARREL TO A LEAKAGE VALVE; where the present invention deals with a barrel connector for coupling a distribution line (15) and a gas line (17) to a barrel (9) comprising a cap (10) provided with a sealed distribution opening (50) and a gas opening (70), said barrel connector comprising: (a) A monoblock integral body comprising a top plate frame (2) defined by a perimeter and comprising a top surface (2t) and a bottom surface (2L) and being provided with a fastening system, said fastening system comprising: (i) Two fastening legs (3) protruding from the bottom surface (2L) of said top plate frame (2), (ii) Two levers (4) protruding from the top surface (2t) of said frame of top plate (2), each of said levers having a coupled end (4c) integrally fixed on the same two opposing perimeter parts of the top plate structure (2) as the hinged ends of the two legs, (b) a distribution tube (5) comprising an upstream part (5u);

Patent document BR 112020016472-0, BEVERAGE DISPENSING SYSTEM INCLUDING SINGLE-USE FLEXIBLE BARRELS, which describes a beverage dispensing system for dispensing a beverage stored in a single-use flexible beverage container including a metering device for at least retrieving information about the beverage and/or the single-use flexible beverage container, and including an electronic sensor device for reading the information from the metering device, thereby establishing digital data representing the information about the beverage and/or the flexible beverage container;

Patent document BR 112021005652-1, RADIO TRANSMITTER DEVICE FOR USE IN METHOD AND SYSTEM FOR PRODUCT FLOW MONITORING, CONTROL and OPTIMIZATION, which describes a liquid product distribution network including a keg distribution monitoring and reporting apparatus for operation with a faucet flow monitoring and reporting apparatus. The keg distribution monitoring and reporting apparatus includes a radio transmitter device and detection circuitry to detect and communicate physical properties associated with the keg. A faucet flow monitoring and reporting apparatus detects liquid flow through a faucet and includes a faucet radio transmitter device for docking and protection by a faucet and a low-power faucet radio/processing module. A mobile communication device with geographic position sensing device and/or said stopcock flow monitoring and reporting apparatus passively and without user interaction within the keg distribution network, without using uplink/gateway loop network devices to detect and report fluid storage, flow, and financial operations related to the distribution of said liquid product through the liquid distribution network;

Patent document BR 102016005061-8, BOTTLE WITH IDENTIFICATION AND IDENTIFICATION SYSTEM THEREOF belonging to the information technology sector, particularly refers to a system that, through a manual scanner, allows the identification of bottles from the same group, with the objective of presenting a solution for the separation of bottles manufactured exclusively for a brewery, from the bottles of its competitors, whether at the time of collection at the point of sale or in industrialization, regardless of their format or volume. The bottle with identification (G) comprises a body (1), equipped on the bottom or any part of its body, with an RFID chip (2), Radio Frequency Identification system. Optionally an RFID tag (3) may be inserted into the label (4) of the bottle (G). The bottle identification system comprises bottles with identifications (G), equipped with RFID chips (2) or RFID tags (3), which receive electromagnetic waves from the RFID scanner (5), which feed an electrical circuit contained in this chip (2) or in the tag (3), responding to the scanner (5);

Patent document WO0017313A1, BREWERY PLANT WITH A CAMERA SURVEILLANCE SYSTEM, relates to a brewery to produce beer, comprising at least one substantially enclosed tank, conduits connecting various parts of said brewery and a control room that is used to control said brewery. At least one camera system is installed inside the tank and/or conduit. The output signal from the camera system may be transmitted to the control room. Processes and/or states occurring within the containers may be monitored using the output data transmitted from the camera system;

Patent document WO0044875A2, BREWERY FACILITY WITH SOUND SURVEILLANCE relates to a brewery facility for brewing comprised of different parts, one of which is designed to monitor and/or control and/or regulate the brewery facility. To monitor, control or acoustically regulate the units and processes in the brewery, a sound detector (6) is mounted directly or indirectly on and/or in at least a part (1, 2, 3, 4, 5) of the brewery premises. The output signal from said detector is transmitted to the process management element;

Patent document ES2776031A1, ACTUATOR FOR BEER DISPENSING TAP, which describes an actuator (1) for beer dispensing taps (2), of the type of taps (2) comprising a neck (20) and a handle (21); which includes:—a clamp (3) complementary to a fixing zone to the tap (2), to be fixed by hugging said zone,—a cam (4) supported on said jaw (3),—a cam drive motor (5) (4), and—a control electronics (6) of the motor (5);

Patent document WO2019010723A1, CONTAINER STRUCTURE FOR STORING LIQUID, where a container structure for storing a liquid is disclosed, the container structure comprising a container body (1) provided with a valve body part allowing the liquid to be fed or pressed out; and further comprising an embedded blocking compound pocket (2), an inner container body (3), a seal (4), a silicon oxide thin film layer (5) and a fiberglass layer (6), wherein in the blocking block the pocket is connected to the valve body part, and has a chamber (20) for holding the liquid; the inner container body is made of HDPE, and the silicon oxide thin film layer is adhered in vacuo to its outer wall; the fiberglass layer is moistened and mixed with an epoxy resin, and then adhered to the outer surface of the silicon oxide thin film layer; and there is also an enclosed space, which allows feeding of a gas, defined between the embedded blocking compound pocket and the inner body of the container. The container structure is simple, rational in design and easy to implement, and not only achieves low-cost production, but can also guarantee the gas barrier property, improve the overall strength of the container and extend the quality assurance period;

Patent document US2007194264A1, FAUCET WITH FLOATING SEAL MEMBER, which describes a liquid dispensing stopcock that includes a flow control lever engaging a sealing element within an internal cavity of a stopcock body. The sealing element is held within the stopcock body in an oversized recess, allowing liquid to flow around all sides of the sealing element when the flow control handle is placed in an open position and liquid flows through the stopcock body. The tap body may have a removable nozzle mounted on a second end of the body. An air inlet may be included within a flow path of the liquid downstream of the sealing element. This air inlet promotes removal of residual liquid from the flow path when the flow lever is in the closed position and is positioned to discourage flow of the liquid through the air inlet when the flow lever is in the open position;

Patent document WO2017111724, BEER TAP FOR AUTOMATIC FOAM CONTROL, which describes a smart beer tap (9) associated with an operating algorithm that is capable of being activated in the desired quantity of beer and in the required head quantity that were previously inserted through a screen, said smart beer tap comprising, in a state capable of being fixed in a tap (3), a tap flow regulating arm (5), which allows passage of the variable flow depending on the tap temperature and the ambient temperature values and the pressure value according to the quantity of beer per the quantity of head required, thus allowing the beer to be poured into a glass optimally, and which is driven by means of a tap flow regulating arm motor (2), and a tap opening/closing arm (4), which is driven by means of a tap opening/closing arm motor (1); and

Patent document U.S. Pat. No. 4,979,641A, COMPUTERIZED BEER DISPENSING SYSTEM, which describes a computerized beverage dispensing system in a first embodiment including an accessory connected to a tap with a thermoelectric heat pump cooled nozzle and an electrically controlled valve, hereinafter valve. A computerized controller is connected to the fitting and tap. The accessory has a tight passage through which the beverage flows under pressure and pressure and temperature transducers to measure the pressure difference through the tight passage and its temperature. The computerized controller includes a pressure lookup table for time used for operation of the timing valve. If abnormal pressure or temperature occurs, the valve is cut off unless a replacement circuit is activated. A front/rear screen shows messages programmed into the computerized controller. A modified connection has a Pitot tube that measures velocity flow to the pressure transducer for use with a velocity/time look-up table for the timing valve in time. In a second embodiment, a counter initially counts the time to dispense a volume of the beverage; adjustment for volume changes is made later by increasing or decreasing the time as needed to dispense the initial volume of the beverage. A third embodiment uses the counting and adjusting technique for beverage dispensing volume control, along with the system input being controlled by a code input corresponding to a stored code. Upon input, a normal key/program (purge) switch in normal controls the normal operation of the system and in program/purge protects the system from all but the key carrier for programming and/or purging.

### SUMMARY

The present invention refers to a new system, a method and a device to promote a compact and direct solution for craft breweries to distribute their products via Kegs, instead of using stainless steel and CO2 barrels, where a polymeric barrel containing an internal plastic balloon (Keg) is used. This balloon is filled with beer, and as it is filled the internal volume of the barrel is occupied; however, the internal volume is not fully filled by the balloon with beer. When full, instead of using CO2, pressurized atmospheric air is applied, without the need for filtration, since, due to having an internal plastic balloon, atmospheric air does not meet the beer. As the beer-filled barrel is filled with air, the plastic balloon is evenly crushed from all directions. While the inner plastic bag is emptied, the internal pressure must be restored with pressurized air. In the end, there is a remnant of +−2% of the total volume of the beer. In this way, the Keg content is served to its entirety, avoiding waste.

The system, method and device for total control of craft breweries, object of the present invention, is intended for breweries in general and particularly for craft breweries, providing breweries with greater control of their assets, by being able to manage specific data at the end of the cold chain, such as temperature, volume, consumption and id of customers.

### BRIEF DESCRIPTION OF DRAWINGS

The following refers to the Figures that accompany this specification, for a better understanding and illustration thereof, where it is seen:

FIG. 1 shows a scheme of the system for total control of craft breweries, object of the present invention, highlighting all its components and operating subsystems, as well as showing a visualization of part of its operation;

FIG. 2 shows a block diagram scheme of the Architecture of the system hardware for total control of craft breweries, object of the present invention;

FIG. 3 shows a block diagram scheme of the Cloud Platform of the system for total control of craft breweries, object of the present invention;

FIG. 4 shows a scheme of the operation flowchart for selling and distributing beer with establishments and customers;

FIG. 5 shows a scheme of the tap-free beer serving device, object of the present invention;

FIG. 6 shows a scheme of the hydraulic manifold, which is intended to receive four different types of beers and exits at a single location.

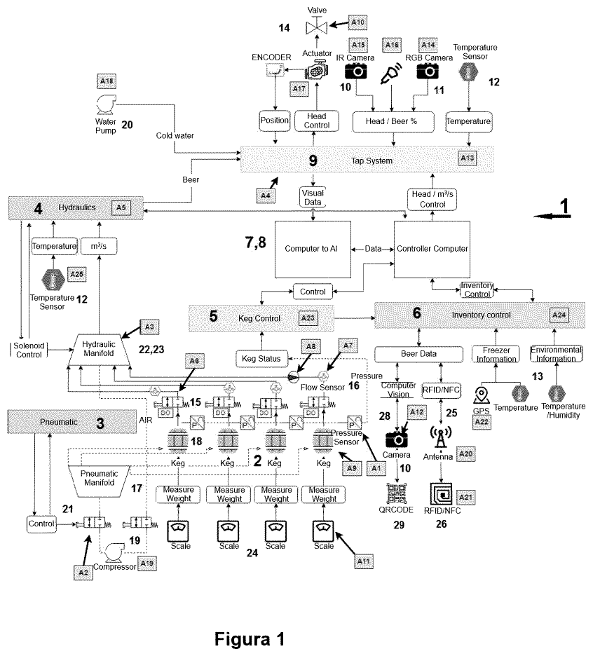

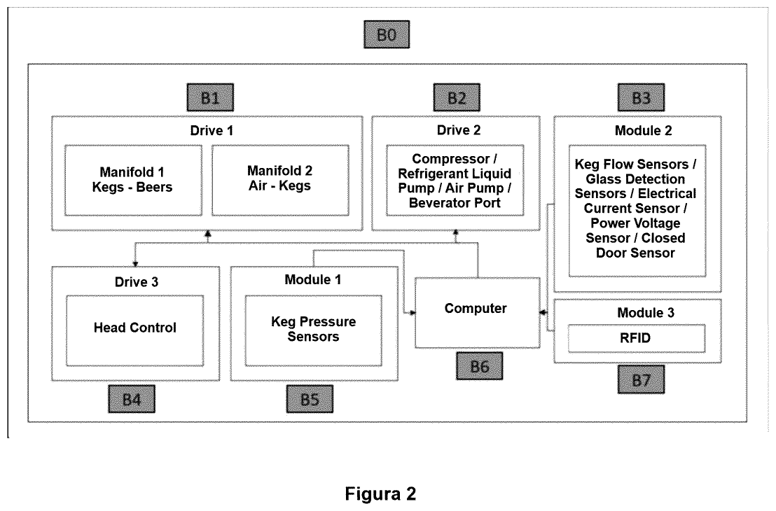

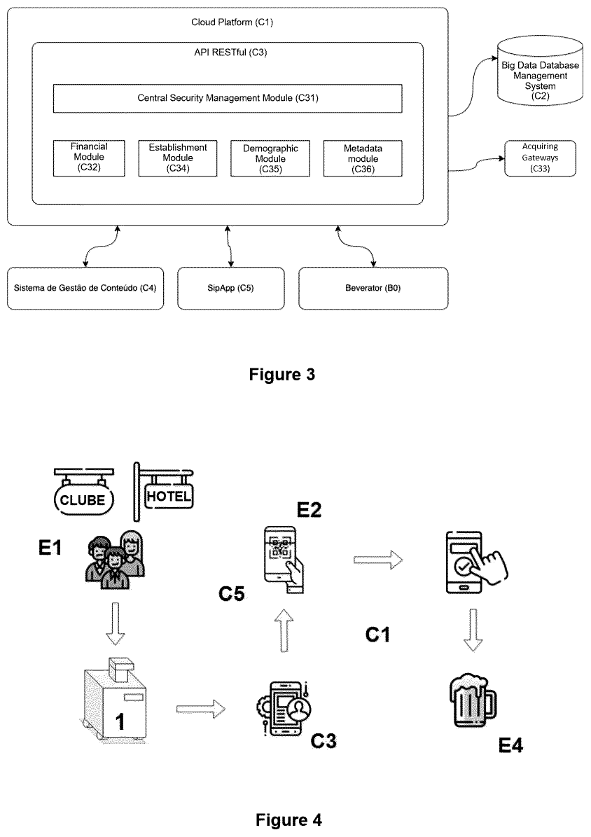

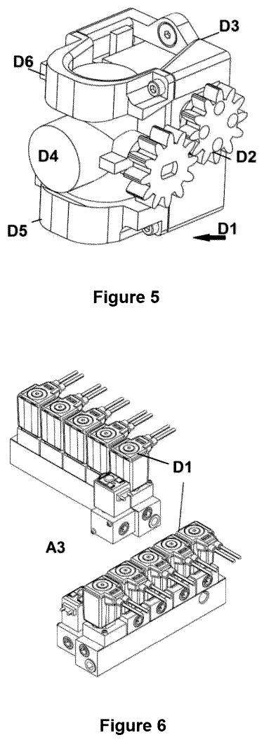

### DETAILED DESCRIPTION

The system, method and device for total control of craft breweries object of the present invention provides breweries with greater control of their assets, by being able to manage specific data at the end of the cold chain, such as temperature, volume, consumption and id of customers, by distributing its products via Keg, which is a polymeric barrel containing an internal plastic balloon (Keg), arranged in a container. This balloon is filled with beer, and as it is filled the internal volume of the barrel is occupied; however, the internal volume is not fully filled by the balloon with beer. When full, instead of using CO2, pressurized atmospheric air is applied, without the need for filtration, since, due to having an internal plastic balloon, atmospheric air does not meet the beer. As the beer-filled barrel is filled with air, the plastic balloon is evenly crushed from all directions. While the inner plastic bag is emptied, the internal pressure must be restored with pressurized air. In the end, there is a remnant of +−2% of the total volume of the beer.

To identify the types of beer that will be internally in the Keg, radio frequency technologies are used. These radio frequency emitting devices vary according to the version of the product, which can be RFID or NFC.

The main changes between RFID or NFC are the types of tags used, since both technologies work with similar principles, being an emitter (antenna) and receivers (tags). With these devices, the system will be able to identify the type of beer that is inside, thus informing the breweries and the end customer what the beer maker with smart refrigerator (freezer) can provide to them.

In the version using NFC tags, the system will be able to know the relative position of the barrels internally in the freezer, reducing the need for manual identification by operators.

When using RFID, the system has an internal camera to identify fiducial patterns or landmarks, through computer vision, which assists the system to identify the position of the beer barrels. The system knowing the individual position of each keg is an important requirement, since when selecting a type of beer, the entire individual system for that barrel must be triggered.

Each keg of beer contains an individual hydraulic and pneumatic system, as well as its entire control system, arranged in a container that can contain more than one keg, forming a smart beer maker. In this way, the system can be scalable, and may contain numerous controlled kegs, or just one, depending on the product version. The smart beer maker contains a total of seven subsystems, namely: pneumatic, hydraulic, keg control, inventory control, cloud system, security and the tap system.

The pneumatic system is responsible for filling the kegs with air, thereby providing sufficient pressure to extract the beer therefrom. To exert air compression and inflate the kegs, a 3 bar compression system is used, containing a DC compressor, pressure switch, pneumatic valve and filter. This assembly operates automatically, and when the system reaches the pressure value of 3 bar, which is controlled by the pressure switch, the compressor is switched off electronically.

However, it is noteworthy that the system proposed here does not use the maximum compressor pressure, since for each type of beer a pressure range is used. This choice of individual pressure control is due to the speed at which the beer must be served, which may vary based on its style, level of carbonation and temperature at which it must be served. The pressure is proportional to the volumetric flow rate at which the beer leaves the keg, since the higher the pressure, the higher the flow rate and speed of the beer.

To control the unit pressure in each keg, a pressure transmitter (A1) is used, which acts directly on the pneumatic line that is connected to the beer barrel. This pressure transmitter sends information to the intelligent freezer logic system, enabling individual keg pressure control. This control allows identification of possible failures and flow control in the hydraulic line. In addition to the pressure transmitters, the pneumatic system has pneumatic valves (A2), which allow or prevent the flow of air into the kegs. These valves allow air to pass through only when the internal pressure in the kegs is below the pressure specified by the control software. The pneumatic system is also responsible for cleaning the hydraulic line between the hydraulic manifold (A3) and the tap (A4). This cleaning is necessary as the system serves different beers, so to prevent mixing of different beers, it is necessary to exhaust this part of the beer line. This cleaning function acts after serving a beer and periodically to prevent the accumulation of possible insects near the tap.

The hydraulic system (A5) is responsible for directing the beer that is extracted from the keg. It contains specific piping for beer, solenoid hydraulic valves (A6), flow sensors (A7), manifold (A3), temperature sensors (A8) and conductivity sensor (A25). The main purpose of hydraulic valves (A6) is to prevent or allow beers to leave the kegs when requested. If they did not exist, the beer would flow due to the pressure difference between the keg (A9) and the hydraulic piping. These valves are actuated via software when there is a purchase request via the end user.

This process works as follows: this end user uses the SIP application to identify the smart freezer and finally select the beer they want to consume. After making the purchase, the supervisor located in the “cloud” sends information to the smart refrigerator (freezer). This information is: desired beer, volume and amount of foam. With the information received, the system acts directly on the hydraulic valve (A10) and other actuators to serve the beer. The hydraulic valves (A10) are contained in a manifold which aims to reduce the pipes to only one, which is connected to the tap outlet. The main objective of the flow sensors (A7) is to identify the instantaneous flow of beer passing through it. In turn, the conductivity sensor can be incorporated with the flow sensor, each beer style has its specific mass and through it, the style and its viscosity can be distinguished. In addition, the conductivity sensor can inform which beer has lower than normal carbonation (amount of CO2 in the beer), thus alerting the system to the need to introduce more CO2 into the beer line or directly into the barrel. With this information, the system can measure the volume that must be served in addition to the total volume that was served from a given keg.

The flow sensor (A7) together with the internal scale system (A11) and the cameras (A12) in the tap system, provide the smart beer maker with enough information to know how much is being served. This information is used from sensor fusion methods, which provide greater reliability to measurements from these sensors. To identify the individual temperatures of the beer lines, temperature sensors (A8) are used. These sensors allow the system to identify if the beer is at the ideal temperature to be served. It is necessary to measure the temperature of the fluid since the kegs are insulating systems, therefore, the internal temperature of the freezer will not necessarily be the same as that of the beer that is contained in the Keg.

The tap system (A13) represents the main set of the freezer or smart beer maker, since it is responsible for serving the product to the end customer. The final consumer (the person who buys the beer) will not have physical contact with the equipment. To order/buy the beer, the user must use the System App, in which they can select the beer, amount of foam and volume of the glass.

In one of the system configurations, the act of serving beer is done autonomously, being the customer's only contact with the glass itself. The system has an artificial intelligence algorithm, which uses computer vision and sensor fusion to identify the relationship between foam and beer in the glass, with the main objective of serving the quantity desired by the customer.

The sensors used for such application are: at least one RGB camera (A14), one IR camera (A15), one ultrasonic sensor (A16), one laser sensor and one LIDAR (Light Detection and Ranging). Using all the data present from these sensors, the system algorithm can detect and control the system to serve the desired amount of beer.

For each type of beer, there are different parameters to serve them, depending on factors such as carbonation, style and viscosity, foam generation becomes unpredictable. Because of this, the AI algorithm is trained on several types of beer before they go to the end customer, thus ensuring the exact percentage of foam that the user requested.

The actuation of the system for foam control is at the kegs pressure, temperature and position of the hydraulic valve opening (A10) by the servo motor (A17). In another configuration of the system proposed herein, a glass lifting and tilting mechanism may be contained. This mechanism aims to reduce turbulence generated when serving beer. For this to occur, the glass is lifted by a lift system and when close to the beer tap, it is tilted. As the beer is served, the mechanism returns to the starting position and releases the glass for use.

To control the foam, the invention does not rely on mechanical taps but on an actuated servo mechanism device that acts as foam is requested. It works as follows: The end customer requests a beer with a high head, so, through computer vision, the system analyzes the amount of beer and foam in the glass, if there is a need to add more foam, the actuated servo mechanism acts in a way that generates more turbulence and, consequently, foam.

### DETAILED DESCRIPTION OF THE INVENTION

The system for total control of craft breweries, object of the present invention, comprises a smart beer maker (1) internally comprising Kegs (2), which are a polymeric barrel containing an internal plastic balloon (Keg), each containing an individual hydraulic and pneumatic system, as well as its entire control system. Said smart beer maker contains seven subsystems, namely: pneumatic (3), hydraulic (4), kegs control (5), inventory and storage control (6), cloud (7), safety (8) and tap (9) subsystems, and also containing the following components: at least one RGB camera (10), an IR camera (11), a laser sensor (12), an ultrasonic sensor (13), a pneumatic solenoid valve (14), a hydraulic solenoid valve (15), a flow sensor (16), a pressure transmitter (17), a plastic keg (18), a compressor (19), a water pump motor (20), a refrigerator (21) (freezer), a hydraulic valve (21), a servo motor (22), a stepper motor (23), a digital scale (24), an RFID antenna (25), an RFID tag (26), an NFC antenna (27) and an NFC tag (28).

The pneumatic subsystem (3) is responsible for cleaning the hydraulic line between the hydraulic manifold (A3) and the tap (A4); and is responsible for filling the kegs with air, thus providing sufficient pressure to extract the beer therefrom. To exert air compression and inflate the kegs, a 3 bar compression system is used, said pneumatic system (3) comprises a DC compressor (19), pressure switch, pneumatic valve (21) with filter, pressure transmitters (17), pneumatic valves (A2), which enable or prevent air flow into the kegs, allowing air to pass only when the internal pressure in the kegs is below the pressure specified by the control software.

The hydraulic subsystem (4) (A5) is responsible for directing the beer that is extracted from the keg, it comprises specific pipes for beer, solenoid hydraulic valves (A6), flow sensors (A7), manifold (A3), temperature sensors (A8) and conductivity sensor (A25); where the hydraulic valves (A6) prevent or enable the beers to leave the kegs (2) when requested, being actuated via software when there is a purchase request via the end user.

The process of actuation of the hydraulic solenoid valves (A6), acts as follows: the end user uses the application to identify the smart beer maker (1) and finally select the beer he wants to consume; after making the purchase, the supervisor located in the “cloud” sends information to the smart beer maker (1); after that, hydraulic valves (A10) contained in a manifold which aims to reduce the pipes to only one, which is connected to the outlet of the tap to serve the beer.

The choice of individual pressure control is given by the speed at which the beer must be served, which may vary from its style, level of carbonation and temperature at which it must be served. The pressure is proportional to the volumetric flow rate at which the beer leaves the keg, since the higher the pressure, the higher the flow rate and speed of the beer. The flow sensor (A7) together with the internal scale system (A11) and the cameras (A12) in the tap system, provide the smart beer maker with enough information to know how much is being served.

To control the unit pressure in each keg, a pressure transmitter (A1) is used, which acts directly on the pneumatic line that is connected to the beer barrel.

The keg control system (5) (BO) is divided into modules, which allows greater ease of detection and corrections and possible detection of failures that may arise, it comprises a drive (B1) responsible for driving two manifolds, one to serve the four types of beers and a second to feed the individualized pressure in each keg (18), a second drive (B2) to drive the compressor to internally cool the brewer (system), a pump for circulation of the refrigerant liquid in the tower that will be served the beer, with the activation of the pressure pump in the line that feeds the air of the Kegs and with the opening and closing of the front port of the beer maker; a third drive (B3) to serve the type of head that the customer desires; data inputs (B4) to monitor the internal pressures of the Kegs (18), set of various sensors (B5), including beer flow at the time of serving, detect the presence or not of a glass to serve a beer, electric current sensor to detect presence of operation of the internal compressor of the chopper, electrical voltage to detect power and presence of energy in the system and finally detect opening or closing of the front port of the chopper; a module (B6) responsible for detecting the presence of kegs inside the chopper and also determining if it is in the correct position to serve the registered type for the respective chopper; and finally, a computer (B7) for monitoring and communicating with the user both to serve and to monitor the system while it is available to serve.

The method for total control of craft breweries, object of the present invention, is a computer vision method with the ability to identify characteristics of the glass used, in addition to segmenting what foam and beer is. The process for recognizing the glass consists of a camera located at the front of the tower, which obtains its images, allowing the artificial intelligence algorithm to treat the image obtained by generating information such as: name of the glass, height, width, among other characteristics, thus starting the process of serving the beer. As the beer is served, the algorithm observes the increment of the liquid, using the same principle for the foam. The complete time for the system to recognize the object is less than 1 second, demonstrating an accuracy in the recognition of the glass in its use.

The use of Artificial Intelligence is essential to offer a beer with quality, right temperature and head based on learning and choice for each customer, being able to inform their favorite beer or even offer a product with flavor like their preference.

The method for total control of craft breweries, object of the present invention, is a cloud operating method, it's comprised of the cloud platform (C1) and is responsible for managing all data and events transacted through the platform by registering them in the Big Data structured database management system (C2) to enable various advanced analysis through the platform and the Content Management System (C4) which is effectively the graphical interface through which users, breweries and employees can create new records, update and view existing records or even when necessary or permitted by security rules, delete data from the platform. Said method comprises a central system, being a RESTful (C3) Application Programming Interface (API) that provides a set of interfaces and access points for all data handled by the system. This central system is divided into modules, whose data storage repositories are decentralized to increase the security of the information recorded in the system. These are: the financial management module (C32), the establishment management module (C34), the people demographics management module (C35) and the metadata module (C36).

The cloud platform (C1) is structured on a central security management module (C31) that ensures the granularity of the management of access rules for each access point, or set of access points, available in the system.

The financial management module (C32) is intended to handle all information related to financial transactions recorded in the system. Consumer data, orders placed in the system, payments recorded, cards stored properly encrypted for PCI Compliance, settings of payment gateways, methods available for payment in addition to the settings of fees for dividing payments between participants in a sale. All transactions carried out through the platform pass through this module that, through integrations, captures transactions in the acquiring gateways (C33) configured in the system and asynchronously receives the transaction status at the gateway, so that when approved, they can allow the payer to dispense the product.

The establishment management module (C34), through this establishment management module, it is possible to manage all breweries contracting the platform, all products marketed and their parameters for service, such as temperature, volumes, percentage of foam and product metadata, such as ibu, abv, color and origin. It is also through this module that the beer makers are activated, thus creating their identifier and QR code, linked to a brewery and a place of use (commercial establishment), that the barrels are registered on the platform, preventing third party barrels from operating on the equipment and providing the integration interfaces for linking the barrels to the products and the beer maker through the identifier of the internal RFID tag of the barrel.

The people demographic data management module (C35) is responsible for managing the demographics of people (C35), whether they are consumers or employees who will work on the platform. This module integrates with third-party systems for verification and validation of “person” data ensuring that, e.g., Brazilian consumers are people duly registered in the Brazilian ID system, as well as those over 18 years old, thus ensuring compliance with local laws.

Finally, the metadata module (C36) is the one that manages all existing data models on the platform, as well as the settings for the content management system, through which all data can be viewed in a structured way as all its characteristics and relationships.

The Content Management System (C4) which is effectively the graphical interface through which users, breweries and employees can create new records, update and view existing records or even when necessary or permitted by security rules, delete data from the platform. This system is self-generated based on the system metadata, so the new metadata records allow the system to generate new graphical interfaces for interaction with users. All modules available through RESTful Application Programming Interfaces have their data managed by this system, which is part of the core package of the platform's cloud systems.

So that end consumers (E1) interact and enjoy the services provided by the platform, the application (C5) was created, through which consumers can register on the cloud platform, thanks to the integration of the application and the RESTful Application Programming Interface made available, storing in the system their demographic data and their preferred credit cards to pay for their purchases. Once properly registered on the platform and close to a beer rack, the application user can scan the QR code (E2) available on the equipment to view all products that are marketed on it. All this is possible thanks to all the settings made in the merchant management module using the Content Management System. Upon receiving the list of beverages available on the equipment, the customer can choose the one he likes best, the volume he wants to serve, within the volumes configured by the brewery and finally make the payment of the product through integration with the financial management module. Once the result of this operation has been an approved payment through the module (C32), the customer will be able to request that the equipment through the integration of the module (C34) of the platform with the system (BO) dispenses the beverage, receiving the guidelines of the system (BO) to place its glass in the place duly informed and wait until the beverage service is completed by the equipment and informed by the system (BO), when the application will finally inform the customer through a notification received by the module (C3) that the beverage is served.

End customer arrives at a location where there is a smart refrigerator. For him to be able to consume beer (E4), it is necessary to be registered in the system, this factor is important to verify if the end customer is over 18 years old. With this, after registering, the customer uses the cell phone camera, through the app, and scans the QRCODE arranged in the refrigerator, and with this he will have access to all types of beers that are arranged in the refrigerator. Once identified, they will be able to order through the app which beer they want, the amount in ml and the type of head, whether it is high, medium or low.

The device for total control of craft breweries, object of the present invention, is a device (D1) for serving beer by actuated servo mechanism (D2) that acts as requested with foam or not; comprising a main body (D3), the beer outlet (D4), servo mechanism (D2), arranged on a support base (D5) for the counter, and a spring mechanism (D6) to hold the glass and leave it in the correct position to serve the beer; where the servo mechanism (D2) acts as requested foam when the end customer requests a beer with a high head, so, by means of computer vision, the system analyzes the amount of beer and foam in the glass.

To control the foam, the system does not have mechanical taps but an actuated servo mechanism that acts as foam is requested when the end customer requests a high head beer, so through computer vision the system analyzes the amount of beer and foam in the glass, if there is a need to add more foam, the actuated servo mechanism acts in a way that generates more turbulence and consequently foam.

It works as follows: the end customer requests a beer (E4) with a high head, so, through computer vision, the system analyzes the amount of beer and foam in the glass, if there is a need to add more foam, the actuated servo mechanism (D2) acts in a way that generates more turbulence and, consequently, foam.

In one of the device configurations (D1), the glass is raised and tilted at 30° to minimize the generated turbulence, it comprises a spring-loaded mechanism (D6) to hold the glass and leave it in the correct position to serve the beer.

The operation is as follows: the end customer places the glass in the center of the glass holder, due to the weight, the system raises three rods from which they hold the glass in the center and does not let it move. After raising, the system has the possibility to tilt the glass up to 30°, depending on the type of beer. After serving, the end customer removes the glass by pulling it up, causing the clamping rods to stop working.

In one of the configurations of the device next to the system, there is the hydraulic manifold (A3), which aims to receive four different types of beers and leave at a single location. In other words, the main objective of using this manifold is to provide only one faucet, thus reducing the complexity and number of elements in the system.

The hydraulic manifold (A3) of the system contains a self-cleaning system which ensures that there is no mixing of beers from which they pass through the internal route of the component. After the system serves the beer, the system triggers a cleaning routine which ensures that there will be no mixing of flavors, thus making it possible for there to be different types of beer styles in the same Keg cooler.

Finally, the cleaning system consists of hydraulic solenoid valves and a pneumatic solenoid valve, the service and cleaning routine are guaranteed by the central system.

Thus, the system, method and device for total control of craft breweries, object of the present invention, is a self-service unit and does not need to be operated by a bartender and waiter; that when the customer wants to buy a glass of beer, he scans with his cell phone through the APP the QR code of the system; this opens the intuitive menu of the system with information about the brewery and the type of beer he can buy, including cost, promotions, coupons and loyalty program; After ordering the beer and authorizing the customer and payment, the system will wait for the glass to be placed under the smart tap and after measuring the size of the glass with our preparatory algorithm the beer will be served; and so the customer will be charged on the volume of beer served in the glass.

The system, method and device for total control of craft breweries, object of the present invention, offers solutions for breweries where the system is managed in all aspects, as it is connected via Wi-Fi or cellular data to the cloud. They can monitor the internal/external state of the system with information on: Beer stock; internal Kegs (Barrels); Ambient temperature; Humidity; Beer line pressure; Quantity sold and revenue; Location of the unit via GPS; Alerts when the beer is finishing for refueling; Informative about the system port when it is opened and closed by the hour and by whom; Alerts when the system needs technical support and cleaning; Monitoring and control of customers who have purchased their products to understand the habits and behaviors for the development of future advertising campaigns; Increase in business profitability and can expand to other sales formats, e.g. Events; Activation of new products; The Application where all the operation of choice until the beer service will be carried out. It will be handled by the end customer with the possibility of creating an account, registering the payment method (credit card); access to the map to find the beer maker; Consumption history; Virtual Store of the registered establishments. Kegs are made of polymer and fiberglass. Spear Bags are Bags made of recycled materials where beer is stored. The system has a complete structure with the freezer where the kegs are and the upper part where the beer tower (tap) is. It has 4 barrels of 20L controlled by RFID system and several sensors that control the quality and health of the machine. The Software-AICloud offers: Intelligent system where all the technical information of the system is stored, such as: Control of the supply-chain; Humidity; Temperature; Internal quality and health of the machine; Storage and quantity of stock; Data on sales and consumer behavior. Artificial intelligence evaluates consumer data and demand by sending that information to breweries. The Fan Display: Volumetric display that produces high-quality holographic images. This device is aimed at presenting products at customers' points of sale.

### BENEFITS

Thus, the system, method and device for total control of craft breweries, object of the present invention, were born to offer the latest in technology, logistics, sales and experience solutions for craft breweries worldwide. The focus is on strengthening brewers and making them earn more through Industry 4.0 technologies, such as IoT (Internet of Things), Artificial Intelligence (AI), Big Data, RFID, Learning Machine, Computer Vision and Cloud. The beverage market has been revolutionized, especially breweries, offering a unique alternative to a new category of experience/solution in the sale and consumption of craft beers.

Through Advanced Artificial Intelligence built into the system and the cloud platform, a perfect glass of beer is provided to the end customer. Through the advantageous solutions of: monitoring of all process parameters from sale and delivery to the consumer; self-service of handmade chop controlled through the APP with standard guarantee; through the technology of Artificial Intelligence built each glass served proportional to a new learning experience and the system becomes increasingly accurate with each new operation; the Kegs (barrels) are lightweight, made of plastic and fiberglass and do not need CO2 to be operated; the system is operated through an application that can be accessed by smartphones and/or tablets of the final consumer and due to the control via mobile application, the system will be able to meet the end users and allow the breweries to know the user profile and obtain a usability stratification; all orders go through the cloud by authorization of the customer, requesting age verification and the chosen payment; and it can also offer 3D hologram technology useful for advertising actions for the breweries and dissemination of the raw material (beers).

Thus, due to the configuration and operating characteristics described above, it can be clearly noted that, it is a system, method and device for total control of craft breweries new to the State of the Art, which has conditions of innovation, inventive step and unprecedented industrialization, which deserve the Privilege of Patent of Invention.

1-18. (canceled)

19. A system for total control of craft breweries, comprising: a smart beer maker with internal kegs, the kegs are composed of a polymeric keg containing an internal plastic balloon, each plastic balloon containing an individual hydraulic and pneumatic system, as well as a control system; said smart beer maker containing seven subsystems, comprising: a pneumatic subsystem, a hydraulic subsystem, a kegs control subsystem, an inventory and inventory control subsystem, a cloud subsystem, a security subsystem, and a tap subsystem, the smart beer maker also containing components of: at least one RGB camera, an IR camera, a laser sensor, an ultrasonic sensor, a pneumatic solenoid valve, a hydraulic solenoid valve, a flow sensor, a pressure transmitter, a plastic keg, a compressor, a water pump motorbike, a refrigerator, a hydraulic valve, a servo motor, a stepper motor, a digital scale, an RFID antenna, a tag RFID, an NFC antenna, and an NFC tag.

20. The system for total control of craft breweries of claim 19, wherein the pneumatic subsystem is responsible for cleaning a hydraulic line between a hydraulic manifold and a tap; the pneumatic subsystem is further responsible for controlling the unit pressure in each keg using a pressure transmitter which acts directly on a pneumatic line that is connected to a beer keg; and the pneumatic subsystem is responsible for filling the kegs with air; said pneumatic subsystem comprises a DC compressor, a pressure switch, a first pneumatic valve with a filter, the pressure transmitters, second pneumatic valves, which allow or prevent the flow of air into the kegs, the second pneumatic valves further allow air to pass only when the internal pressure in the kegs is below the pressure specified by a control software.

21. The system for total control of craft breweries of claim 19, wherein the hydraulic subsystem is responsible for directing beer that is extracted from the keg comprises specific pipes for beer, solenoid hydraulic valves, flow sensors, the hydraulic manifold, temperature sensors and a conductivity sensor; where the solenoid hydraulic valves prevent or allow beer to leave the kegs when requested, being actuated via a software when there is a purchase request via an end user.

22. The system for total control of craft breweries of claim 21, wherein the solenoid hydraulic valves act when an end user uses an application to identify the smart beer maker and the end user selects a beer to be consumed; after the end user selects a beer to be consumed, a supervisor located in the cloud subsystem sends information to the smart beer maker; then the solenoid hydraulic valves that are contained in the hydraulic manifold, are connected to a tap outlet to serve beer, open a beer outlet.

23. The system for total control of craft breweries of claim 19, wherein a keg control subsystem is divided into modules, the keg control subsystem comprises a first drive, the first drive is responsible for driving two hydraulic manifolds, one hydraulic manifold to serve four types of beer and a second hydraulic manifold to feed the individualized pressure in each keg, a second drive to drive the compressor to internally cool the smart beer maker, a pump for circulating refrigerant liquid in a tower that will be served beer, with activation of the pressure pump in a line that feeds air of the kegs and with opening and closing of a front port of the smart beer maker; a third drive to serve a type of head that a customer wishes; data inputs to monitor the internal pressures of the Kegs, the third drive to set of various sensors, including beer flow at the time of serving, the third drive to detect a presence or not of a glass to serve beer, electric current sensor to detect a presence of operation of an internal compressor of the smart beer maker, electrical voltage to detect power and presence of energy in the keg control subsystem and finally detect opening or closing of a front port of the smart beer maker; a module is responsible for detecting a presence of kegs inside the smart beer maker and also determining if it is in the correct position to serve a registered type for the respective smart beer maker; and finally, a computer for monitoring and communicating with a user both to serve and to monitor the keg control subsystem while it is available to serve.

24. A computer vision method for total control of craft breweries using artificial intelligence to control an entire system of an intelligent smart beer maker, comprising: identifying characteristics of a glass used, segmenting what is foam and beer; where a process for a recognition of bodies is composed of a camera located in front of the tower, the camera obtains images thereof, allowing an artificial intelligence algorithm to treat the image obtained generating information including a name of a glass, a height, and a width, thus starting a process of serving a beer, so that as the beer is served the artificial intelligence algorithm observes an increase of liquid, using the same principle for foam, and the complete time for the system for total control of craft breweries to recognize an object is less than 1 second.

25. The computer vision method for total control of craft breweries of claim 24, further comprising a cloud operating method, wherein a cloud platform is responsible for managing all data and events transacted through the cloud platform, recording them in a big data structured database management system to enable several advanced analyzes through the cloud platform, and a content management system that is a graphical interface through which users, breweries and employees can create new records, update and view existing records or delete data from the cloud platform; said method further comprises a central system and is a RESTful Application Programming Interface (API) that provides a set of interfaces and access points for all data handled by the content management system, with a central system that is divided into modules, whose data storage repositories are decentralized, these modules being: a financial management module, an establishment management module, a people demographic data management module, and a metadata module.

26. The computer vision method for total control of craft breweries of claim 25, wherein the cloud platform is structured on a central security management module that guarantees a granularity of a management of access rules for each access point, or set of access points, available in the content management system.

27. The computer vision method for total control of craft breweries of claim 25, wherein the content management system further comprises a graphical interface through which users, breweries, and employees can create new records, update and view existing records, and/or delete data from the platform; said content management system is self-generated based on metadata of the smart beer maker, where all modules available by the RESTful Application Programming Interfaces have their data managed by the content management system, which is part of a central package of the cloud platform.

28. The computer vision method for total control of craft breweries of claim 24, wherein the financial management module handles all information related to financial transactions recorded in the content management system, which include: consumer data, orders placed in the content management system, payments recorded, stored cards properly encrypted for PCI Compliance, payment gateway settings, methods available for payment, and payment split fee settings among participants in a sale; where all transactions made through the cloud platform pass through the financial management module that through integrations captures transactions on acquiring gateways configured in the content management system and asynchronously receives a transaction status at the gateway, so that when approved the content management system allows a payer to dispense a product.

29. The computer vision method for total control of craft breweries of claim 24, wherein the establishment management module is a module that manages all breweries contracting the cloud platform, all marketed products and their parameters for service, including temperature, volumes, percentage of foam, and product metadata, including ibu, abv, color, and origin; the establishment management module activates brewers creating their identifier and QR code, linked to a brewery and a place of use; the establishment management module where the kegs are registered on the cloud platform and provides integration interfaces for linking the kegs to products and to a brewer through a identifier of an internal RFID tag thereof.

30. The computer vision method for total control of craft breweries of claim 24, wherein the people demographic data management module manages demographic data of people, including both consumers and/or employees who work on the cloud platform; the people demographic data management module integrates with third-party systems for verification and validation of personal data ensuring that consumers are people duly registered in an ID system to ensure compliance with local laws.

31. The computer vision method for total control of craft breweries of claim 24, wherein the metadata module manages all existing data models on the cloud platform, as well as settings for the content management system, through which all the data can be visualized in a structured way as all its characteristics and relationships.

32. The computer vision method for total control of craft breweries of claim 24, wherein said method for total control of craft breweries comprises an application, through which final consumers can register on the cloud platform, using an application integration and the available RESTful Application Programming Interface, storing in the content management system the final consumers' demographic data and the final consumers' preferred credit cards to pay for the final consumers' purchases, to interact and enjoy services provided by the cloud platform; where an application user can scan the QR code available on an equipment to view all products that are marketed in the equipment, which chooses the application user likes best, a volume the application user wants to serve, within volume configured by a brewery, and the application user makes the payment of a product through the application integration with the financial management module, which, once approved through the financial management module, a customer will be able to request that the equipment through the application integration of the establishment management module of the cloud platform with the keg control subsystem dispenses beverage, receiving guidelines of the keg control subsystem to place a glass in a place duly informed and the customer waits until a beverage service is finished by the equipment and informed by the keg control subsystem, when the application will finally inform the customer through a notification received by the establishment management module that the beverage is served.

33. A device for total control of craft breweries, and for serving beer by an actuated servomechanism that acts as requested with foam or not; the device comprising a main body, a beer outlet, a servomechanism, arranged on a support base for a counter, and a spring mechanism to hold a glass and leave it in the correct position to serve beer; wherein a servomechanism acts as requested foam when an end customer requests a high head beer, so, by means of computer vision, the keg control subsystem analyzes an amount of beer and foam in a glass.

34. The device for total control of craft breweries of claim 33, wherein, a glass is raised and tilted at 30° to minimize a generated turbulence.

35. The device for total control of craft breweries of claim 33, wherein in a configuration where the device is next to the keg control subsystem, there is the hydraulic manifold which receives four different types of beer and exits by a single location.

36. The device for total control of craft breweries of claim 35, wherein the hydraulic manifold contains a self-cleaning system of the device for total control of craft breweries that is activated automatically after the keg control subsystem serves the beer.
